(19) United States
(12) Patent Application Publication
(10) Pub. No.: US 2018/0288320 A1
(43) Pub. Date: Oct. 4, 2018

(54) Camera Fields of View for Object Detection

(71) Applicant: Uber Technologies, Inc., San Francisco, CA (US)

(72) Inventors: Peter Melick, Pittsburgh, PA (US); Jay Kuvelker, Pittsburgh, PA (US); Brian Thomas Zajac, Wexford, PA (US); Carl Wellington, Pittsburgh, PA (US)

(21) Appl. No.: 15/477,638

(22) Filed: Apr. 3, 2017

(51) Int. Cl. H04N 5/232; H04N 7/18; G06K 9/00; G06K 9/62; G05D 1/00; G05D 1/02; B60R 1/00; G01S 17/02; G01S 17/10; G01S 7/486

(52) U.S. Cl. CPC H04N 5/23238; H04N 7/181; G06K 9/00805; G06K 9/628; G05D 1/0088; B60R 2300/303; B60R 1/00; G01S 17/023; G01S 17/10; G01S 7/4865; B60R 2300/105; G05D 1/0246

(57) ABSTRACT

The present disclosure provides systems and methods for detecting, localizing, and classifying objects that are proximate to an autonomous vehicle. A sensor system can include one or more ranging systems and a plurality of cameras. The plurality of cameras can be positioned such that a field of view for each camera of the plurality of cameras overlaps a field of view of at least one adjacent camera. The one or more ranging systems can be configured to transmit ranging data to a perception system for detecting objects of interest and the plurality of cameras can be configured to transmit image data to the perception system for classifying the objects of interest.

### FIELD

The present disclosure relates generally to detecting objects of interest. More particularly, the present disclosure relates to detecting and classifying objects that are proximate to an autonomous vehicle in part by using overlapping camera fields of view.

### BACKGROUND

An autonomous vehicle is a vehicle that is capable of sensing its environment and navigating with little to no human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion path through such surrounding environment.

Thus, a key objective associated with an autonomous vehicle is the ability to perceive objects (e.g., vehicles, pedestrians, cyclists) that are proximate to the autonomous vehicle and, further, to determine classifications of such objects as well as their locations. The ability to accurately and precisely detect and characterize objects of interest is fundamental to enabling the autonomous vehicle to generate an appropriate motion plan through its surrounding environment.

### SUMMARY

Aspects and advantages of embodiments of the present disclosure will be set forth in part in the following description, or can be learned from the description, or can be learned through practice of the embodiments.

One example aspect of the present disclosure is directed to a sensor system. The sensor system includes one or more ranging systems and a plurality of cameras. The plurality of cameras are positioned such that a field of view for each camera of the plurality of cameras overlaps a field of view of at least one adjacent camera. The plurality of cameras are further positioned about at least one of the one or more ranging systems such that a combined field of view of the plurality of cameras comprises an approximately 360 degree field of view. The one or more ranging systems are configured to transmit ranging data to a perception system for detecting objects of interest and the plurality of cameras are configured to transmit image data to the perception system for classifying the objects of interest.

Another example aspect of the present disclosure is directed to an autonomous vehicle. The autonomous vehicle includes a vehicle computing system and a sensor system. The vehicle computing system includes one or more processors and one or more memories including instructions that, when executed by the one or more processors, cause the one or more processors to perform operations. The operations include detecting objects of interest and classifying the detected objects of interest. The sensor system includes a plurality of cameras, the plurality of cameras are positioned such that a field of view for each camera of the plurality of cameras overlaps a field of view of at least one adjacent camera and the plurality of cameras are configured to transmit image data to the vehicle computing system for classifying objects of interest. In some embodiments, the autonomous vehicle may further include one or more ranging systems. The one or more ranging systems may be configured to transmit ranging data to the vehicle computing system for detecting where the objects of interest are located proximate to the autonomous vehicle.

Another example aspect of the present disclosure is directed to a computer-implemented method of detecting objects of interest. The method includes receiving, by one or more computing devices, ranging data from one or more ranging systems, the ranging systems being configured to transmit ranging signals relative to an autonomous vehicle. The method includes receiving, by the one or more computing devices, image data from a plurality of cameras configured to capture images relative to the autonomous vehicle. The plurality of cameras being positioned such that a field of view for each camera of the plurality of cameras overlaps a field of view of at least one adjacent camera. The method includes detecting, by the one or more computing devices, an object of interest proximate to the autonomous vehicle within the ranging data. The method includes determining, by the one or more computing devices, a first image area within image data captured by a first camera within the plurality of cameras containing the object of interest. The method includes determining, by the one or more computing devices, a second image area within image data captured by a second camera within the plurality of cameras containing the object of interest, the second image area overlapping the first image area and providing a greater view of the object than provided in the first image area. The method includes classifying, by the one or more computing devices, the object of interest based at least in part on the second image area.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system for controlling the navigation of a vehicle according to example embodiments of the present disclosure;

FIG. 2 illustrates fields of view for a plurality of cameras in relation to example objects of interest according to example embodiments of the present disclosure;

FIG. 3 depicts an example autonomous vehicle sensor system according to example embodiments of the present disclosure;

FIG. 4 depicts an example autonomous vehicle sensor system in relation to example objects of interest according to example embodiments of the present disclosure;

FIG. 5 depicts an example of adjacent rear view detection according to example embodiments of the present disclosure;

FIG. 6 depicts a block diagram of a camera system according to example embodiments of the present disclosure;

FIG. 7 depicts a flow diagram of an example method of providing sensor data for use in object detection according to example embodiments of the present disclosure;

FIG. 8 illustrates an example of camera-LIDAR parallax; and

FIG. 9 illustrates an example computing system according to example embodiments of the present disclosure.

### DETAILED DESCRIPTION

Generally, the present disclosure is directed to systems and methods for detecting and classifying objects, such as pedestrians, cyclists, other vehicles (whether stationary or moving), and the like, during the operation of an autonomous vehicle. In particular, in some embodiments of the present disclosure, when deploying a plurality of cameras as part of a vehicle sensor system, the positions and orientations of the cameras can be configured such that the field of view of each camera is overlapped by the field of view of at least one adjacent camera by a determined amount. Such camera field of view overlaps allow for an object of interest that may be captured in image data on a boundary or edge of one camera's field of view to be more fully captured within the field of view of an adjacent camera and thereby provide for improved detection and classification of the object of interest. For example, without such camera field of view overlaps, an object, such as a pedestrian, that may be on a boundary of a first camera's field of view may be only partially captured (e.g., “split”) in that camera's image data increasing the difficulty in detecting and classifying the object as a pedestrian. However, by configuring the cameras with field of view overlaps, such a “split” object can be more fully captured in the image data of an adjacent camera and thereby allow for properly identifying and classifying the object, for example, as a pedestrian (e.g., capturing at least a sufficient portion of the object of interest by the adjacent camera to allow for classification).

For example, in some embodiments, one or more camera field of view overlaps can be configured such that the field of view overlap is large enough in certain locations for a largest relevant classifiable object within a given category of objects to be fully captured by one camera. For example, given a particular category of classifiable objects (e.g., pedestrians), a field of view overlap can be configured to be large enough within a certain range of the autonomous vehicle such that a largest relevant pedestrian (e.g., an adult male as compared with other types of pedestrians such as adult females and children) near the autonomous vehicle may be fully viewed in at least one camera's field of view (e.g., a pedestrian on a boundary of one camera's field of view can be fully captured in an adjacent camera's field of view due to the field of view overlaps). It should be appreciated that this example configuration for a field of view overlap is also designed with specific consideration to the different categories of classifiable objects (e.g., pedestrians, bicycles, vehicles) such that the category of classifiable objects having a typically smallest dimension (e.g., pedestrians as opposed to bicycles or vehicles) can be fully viewed in at least one camera's field of view

In some embodiments, a field of view overlap may be configured based on a minimum amount of view of an object that is needed to determine an object classification. For example, if, in a particular embodiment, a classification can generally be determined from a camera's image data that contains at least 20% of a view of an object, such as a bicycle for example, the field of view overlap may be configured such that an overlap at least as large as 20% of the size of such object is provided.

In some embodiments, a field of view overlap may be configured based on a minimum or average dimension of an object type that is generally difficult to classify when captured on a camera's field of view boundary. For example, considering a pedestrian category of detectable objects, such objects may have different average sizes depending on whether a pedestrian is a male, a female, a child, etc. Since male pedestrians can be considered the largest relevant classifiable object within the pedestrian category, the field of view overlap can be designed to be large enough that the typical adult male pedestrian would be fully captured by one camera. More particularly, since a larger pedestrian (e.g., a male pedestrian), generally has a width dimension of at least twenty inches, then a field of view overlap may be configured so that the overlap is at least twenty inches wide at a small distance from the vehicle so that such an object (e.g., male pedestrian) could be fully captured by at least one camera.

In some embodiments, the positions and orientations of one or more of the cameras can also be configured to provide a full line horizontal field of view adjacent to an autonomous vehicle so that, for example, objects proximate to the vehicle, or farther back to the rear of the vehicle, in an adjacent lane can be more easily detected. An autonomous vehicle sensor system including one or more ranging systems and a plurality of cameras configured to provide field of view overlaps among the cameras can provide ranging data and image data (or combined “sensor data”) that allow for improved detection of objects of interest around the periphery of the autonomous vehicle and improved localization and classification of the objects of interest. The data regarding the localization and classification of the objects of interest can be further analyzed in autonomous vehicle applications, such as those involving perception, prediction, motion planning, and vehicle control.

More particularly, an autonomous vehicle sensor system can be mounted on the roof of an autonomous vehicle and can include one or more ranging systems, for example a Light Detection and Ranging (LIDAR) system and/or a Radio Detection and Ranging (RADAR) system. The one or more ranging systems can capture a variety of ranging data and provide it to a vehicle computing system, for example, for the detection and localization of objects of interest during the operation of the autonomous vehicle. The one or more ranging systems may include a single centrally mounted LIDAR system in some examples. In some examples, the centrally mounted LIDAR system may be tilted forward to provide the desired coverage pattern.

As one example, for a LIDAR system, the ranging data from the one or more ranging systems can include the location (e.g., in three-dimensional space relative to the LIDAR system) of a number of points that correspond to objects that have reflected a ranging laser. For example, a LIDAR system can measure distances by measuring the Time of Flight (TOF) that it takes a short laser pulse to travel from the sensor to an object and back, calculating the distance from the known speed of light.

As another example, for a RADAR system, the ranging data from the one or more ranging systems can include the location (e.g., in three-dimensional space relative to the RADAR system) of a number of points that correspond to objects that have reflected a ranging radio wave. For example, radio waves (pulsed or continuous) transmitted by the RADAR system can reflect off an object and return to a receiver of the RADAR system, giving information about the object's location and speed.

The autonomous vehicle sensor system can also include a plurality of cameras oriented and positioned relative to the one or more ranging systems, such as a centrally mounted LIDAR system. The plurality of cameras can capture image data corresponding to objects detected by the one or more ranging systems and provide the image data to a vehicle computing system, for example, for identification and classification of objects of interest during the operation of the autonomous vehicle. The positions and orientations for the plurality of cameras can be determined and configured such that a field of view for each camera of the plurality of cameras overlaps a field of view of at least one adjacent camera, for example, by a determined amount. These camera field of view overlaps may provide improvements in the detection, localization, and classification of objects of interest. For example, the camera field of view overlaps may provide that at least one camera of the plurality of cameras will have a more full view (e.g., not a split or left/right view) of an object, such as a pedestrian or cyclist, that is sensed with a LIDAR device. In some examples, the ranging system and plurality of cameras with field of view overlaps can provide for improved detection of smaller and/or fast moving objects, such as a pedestrian or cyclist, such as by providing a horizontal field of view adjacent to an autonomous vehicle that provides a full view along a line (e.g., providing a horizontal field of view of the lane adjacent and to the rear of the autonomous vehicle).

In some embodiments, the position and orientation of some of the cameras may be configured to provide a horizontal field of view tangent to a side of an autonomous vehicle so that objects farther back in an adjacent lane can be detected, such as for use in analyzing a lane change or merging operation of the vehicle, for example. Configuring the position and orientation of one or more cameras to provide such a horizontal field of view tangent to a side of an autonomous vehicle could provide a field of view similar to that of a side view mirror as used by a vehicle driver, and provide for viewing objects adjacent to the autonomous vehicle in a similar fashion. A field of view tangent to a side of an autonomous vehicle can be provided by positioning one or more rear side or rear facing cameras proximate to a roof edge of the autonomous vehicle. For example, in some embodiments, a left rear side camera can be mounted near the left edge of the roof of the autonomous vehicle and a right rear side camera can be mounted near the right edge of the roof of the autonomous vehicle.

In some embodiments, one or more rear facing cameras (e.g., left rear side camera, right rear side camera) positioned near the roof edge of the autonomous vehicle can provide an improved view as compared to a rear camera positioned on or near the centerline of an autonomous vehicle. For example, having a rear facing camera (e.g., left rear side camera, right rear side camera) positioned near a roof edge of the autonomous vehicle can provide an improved rear facing view of the adjacent lane when a large vehicle (e.g., bus, truck, etc.) is positioned immediately behind the autonomous vehicle, whereas the field of view for a centerline-placed rear camera could be greatly obscured by such a large vehicle. For example, one or more rear side cameras positioned nearer to a roof edge of the autonomous vehicle could provide a view similar to that of a side view mirror as used by a vehicle driver as opposed to the field of view of a centerline-positioned camera which could be comparable to a vehicle driver's view in a rear-view mirror where large following vehicles can obscure the view. In some examples, the plurality of cameras can also be positioned around and relative to the one or more ranging systems, such as a central LIDAR system, for example, such that the combined field of view of the plurality of cameras provides an approximately 360 degree horizontal field of view around the LIDAR system or the periphery of the autonomous vehicle.

In some embodiments, the plurality of cameras in the sensor system can include at least five cameras having a wide field of view to provide the adequate fields of view surrounding an autonomous vehicle. For example, the plurality of cameras may include a forward-facing camera, two forward side cameras, and two rear side cameras. In some embodiments, the plurality of cameras in the sensor system may include six cameras having a wide field of view to provide the adequate field of view surrounding an autonomous vehicle. For example, the plurality of cameras may include a forward-facing camera, two forward side cameras, two rear side cameras, and a rear-facing camera. In some implementations, more or less cameras can be utilized.

In some embodiments, the position and orientation of the plurality of cameras may be configured to provide some front bias in field of view overlap, for example, due to a higher likelihood of objects necessitating detection and classification approaching from the front and/or front sides of an autonomous vehicle while in operation. In such examples, the cameras may be configured to provide less overlap in a rear-facing direction as an autonomous vehicle is less likely to move in reverse at a high rate of speed. For example, front bias may be provided by configuring two or more forward facing cameras with larger forward field of view overlaps and two or more rearward facing cameras with smaller rear field of view overlaps.

In some embodiments, components of the sensor system, such as the ranging system and some of the plurality of cameras, may be configured in positions more forward on the roof of the autonomous vehicle, for example, to more closely align with a driver's head position and provide improved perception of oncoming terrain and objects. For example, forward facing and forward side cameras, and possibly the LIDAR system, may be mounted on the roof of the autonomous vehicle such that they are not positioned behind a driver seat position in the autonomous vehicle. In some embodiments, a forward-facing camera of the sensor system can also be positioned and oriented to be able to see a traffic control signal while the autonomous vehicle is stationary at an intersection.

In some embodiments, some or all of the cameras of the plurality of cameras may have a horizontal field of view of less than about 90 degrees, and in some examples, the camera horizontal field of views may be tighter (e.g., less than 83 degrees). In some embodiments, the plurality of cameras may be configured such that the cameras do not pitch down more than a certain range (e.g., approximately 10 degrees). In some embodiments, the ranging system and camera components of the sensor system can be configured such that they would not overhang a roof edge of the autonomous vehicle. For example, such placement can provide the advantage of reducing the possibility of a user contacting the sensor components, such as when entering or exiting the vehicle.

In some embodiments, a roof-mounted sensor system may provide a ground intercept within a defined range of the vehicle, for example, providing a ground intercept within a certain distance (e.g., four meters) of the vehicle relative to the front and sides of the vehicle. In some embodiments, the sensor system LIDAR may provide a ground intercept within a certain distance (e.g., five meters) of the vehicle and the sensor system cameras may provide a ground intercept within a certain distance (e.g., four meters) of the vehicle.

In some embodiments, the placement and orientation of one or more of the cameras relative to the LIDAR system may be configured to provide improvements in parallax effects relative to the objects detected within the ranging data from the LIDAR system and within the image data from the plurality of cameras. The placement and orientation of the LIDAR system and cameras may be configured, in particular, to minimize camera-LIDAR parallax effects, both horizontal and vertical, for a forward 180-degree view.

In some embodiments, the sensor system may also include one or more near-range sensor systems, for example, RADAR, ultrasonic sensors, and the like. Such near-range sensor systems may provide additional sensor data in regard to objects located in one or more close-in blind spots in LIDAR and/or camera coverage around an autonomous vehicle while the vehicle is either stationary or moving.

An autonomous vehicle can include a sensor system as described above as well as a vehicle computing system. The vehicle computing system can include one or more computing devices and one or more vehicle controls. The one or more computing devices can include a perception system, a prediction system, and a motion planning system that cooperate to perceive the surrounding environment of the autonomous vehicle and determine a motion plan for controlling the motion of the autonomous vehicle accordingly. The vehicle computing system can receive sensor data from the sensor system as described above and utilize such sensor data in the ultimate motion planning of the autonomous vehicle.

In particular, in some implementations, the perception system can receive sensor data from one or more sensors (e.g., one or more ranging systems and/or the plurality of cameras) that are coupled to or otherwise included within the sensor system of the autonomous vehicle. The sensor data can include information that describes the location (e.g., in three-dimensional space relative to the autonomous vehicle) of points that correspond to objects within the surrounding environment of the autonomous vehicle (e.g., at one or more times).

As yet another example, for one or more cameras, various processing techniques (e.g., range imaging techniques such as, for example, structure from motion, structured light, stereo triangulation, and/or other techniques) can be performed to identify the location (e.g., in three-dimensional space relative to the one or more cameras) of a number of points that correspond to objects that are depicted in imagery captured by the one or more cameras. Other sensor systems can identify the location of points that correspond to objects as well.

The perception system can identify one or more objects that are proximate to the autonomous vehicle based on sensor data received from the one or more sensors. In particular, in some implementations, the perception system can determine, for each object, state data that describes a current state of such object. As examples, the state data for each object can describe an estimate of the object's: current location (also referred to as position); current speed; current heading (current speed and heading also together referred to as velocity); current acceleration; current orientation; size/footprint (e.g., as represented by a bounding shape such as a bounding polygon or polyhedron); class of characterization (e.g., vehicle versus pedestrian versus bicycle versus other); yaw rate; and/or other state information. In some implementations, the perception system can determine state data for each object over a number of iterations. In particular, the perception system can update the state data for each object at each iteration. Thus, the perception system can detect and track objects (e.g., vehicles, bicycles, pedestrians, etc.) that are proximate to the autonomous vehicle over time.

The prediction system can receive the state data from the perception system and predict one or more future locations for each object based on such state data. For example, the prediction system can predict where each object will be located within the next 5 seconds, 10 seconds, 20 seconds, etc. As one example, an object can be predicted to adhere to its current trajectory according to its current speed. As another example, other, more sophisticated prediction techniques or modeling can be used.

The motion planning system can determine a motion plan for the autonomous vehicle based at least in part on predicted one or more future locations for the object and/or the state data for the object provided by the perception system. Stated differently, given information about the current locations of proximate objects and/or predicted future locations of proximate objects, the motion planning system can determine a motion plan for the autonomous vehicle that best navigates the autonomous vehicle along the determined travel route relative to the objects at such locations.

As one example, in some implementations, the motion planning system can determine a cost function for each of one or more candidate motion plans for the autonomous vehicle based at least in part on the current locations and/or predicted future locations of the objects. For example, the cost function can describe a cost (e.g., over time) of adhering to a particular candidate motion plan. For example, the cost described by a cost function can increase when the autonomous vehicle approaches possible impact with another object and/or deviates from a preferred pathway (e.g., a predetermined travel route).

Thus, given information about the current locations and/or predicted future locations of objects, the motion planning system can determine a cost of adhering to a particular candidate pathway. The motion planning system can select or determine a motion plan for the autonomous vehicle based at least in part on the cost function(s). For example, the motion plan that minimizes the cost function can be selected or otherwise determined. The motion planning system then can provide the selected motion plan to a vehicle controller that controls one or more vehicle controls (e.g., actuators or other devices that control gas flow, steering, braking, etc.) to execute the selected motion plan.

The systems and methods described herein may provide a number of technical effects and benefits. For instance, sensor systems employing a plurality of cameras with strategic field of view overlaps as described herein provide for enhanced field of view for use in object detection and classification. Such enhanced field of view can be particularly advantageous for use in conjunction with vehicle computing systems for autonomous vehicles. Because vehicle computing systems for autonomous vehicles are tasked with repeatedly detecting and analyzing objects in sensor data for localization and classification of objects of interest including other vehicles, cyclists, pedestrians, traffic changes, traffic control signals, and the like, and then determining necessary responses to such objects of interest, enhanced field of view can lead to faster and more accurate object detection and classification. Improved object detection and classification can have a direct effect on the provision of safer and smoother automated control of vehicle systems and improved overall performance of autonomous vehicles.

The systems and methods described herein may also provide a technical effect and benefit of providing for improved placement of cameras as part of an autonomous vehicle sensor system. The analysis of appropriate fields of view and field of view overlaps for a sensor system may provide for improving the placement and orientation of cameras within the sensor system to provide more robust sensor data leading to improvements in object perception by vehicle computing systems. The improved placement of cameras in an autonomous vehicle sensor system may also provide a technical effect and benefit of reducing parallax effects relative to the ranging data provided by a LIDAR system and image data provided by the plurality of cameras, thereby improving the localization of detected objects of interest, as well as improving the prediction and motion planning relative to the objects of interest, by vehicle computing systems.

The systems and methods described herein may also provide a technical effect and benefit of providing improvements in object detection relative to alternative solutions for combining image data from multiple cameras. For example, performing image stitching of images from multiple cameras can introduce stitching artifacts jeopardizing the integrity of image data along image boundaries that are stitched together. Also, cameras that are designed to obtain images that will be stitched together can sometimes be subject to design limitations such as the size and placement of the cameras, for example, in a ring that is very close together.

The systems and methods described herein may also provide resulting improvements to computing technology tasked with object detection and classification. Providing improvements in fields of view and improvements in sensor data may provide improvements in the speed and accuracy of object detection and classification, resulting in improved operational speed and reduced processing requirements for vehicle computing systems, and ultimately more efficient vehicle control.

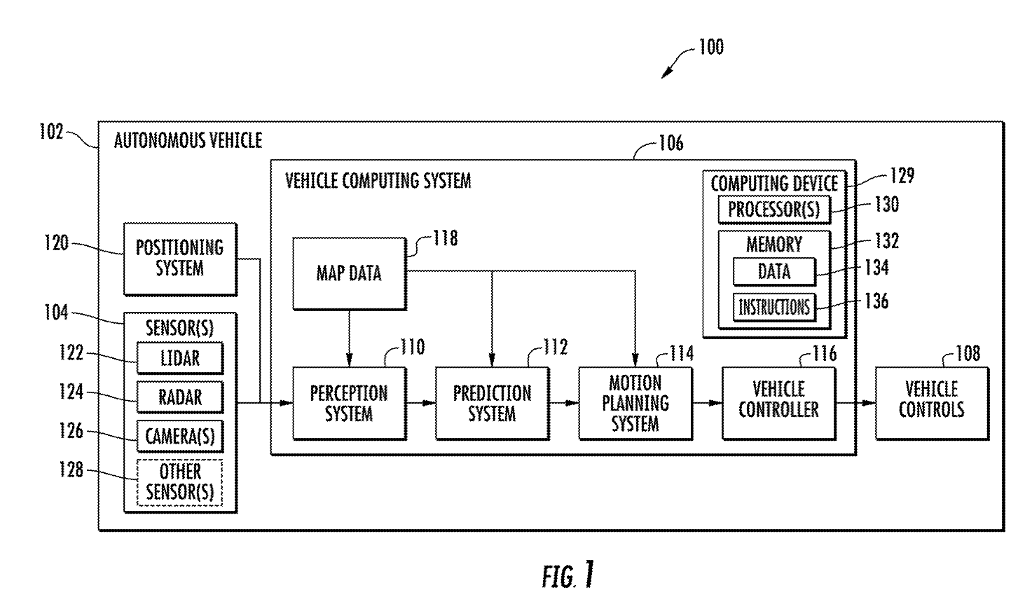

With reference to the figures, example embodiments of the present disclosure will be discussed in further detail. FIG. 1 depicts a block diagram 100 of an example system for controlling the navigation of an autonomous vehicle 102 according to example embodiments of the present disclosure. The autonomous vehicle 102 is capable of sensing its environment and navigating without human input. The autonomous vehicle 102 can be a ground-based autonomous vehicle (e.g., car, truck, bus, etc.), an air-based autonomous vehicle (e.g., airplane, drone, helicopter, or other aircraft), or other types of vehicles (e.g., watercraft). The autonomous vehicle 102 can be configured to operate in one or more modes, for example, a fully autonomous operational mode and/or a semi-autonomous operational mode. A fully autonomous (e.g., self-driving) operational mode can be one in which the autonomous vehicle can provide driving and navigational operation with minimal and/or no interaction from a human driver present in the vehicle. A semi-autonomous (e.g., driver-assisted) operational mode can be one in which the autonomous vehicle operates with some interaction from a human driver present in the vehicle.

The autonomous vehicle 102 can include one or more sensors 104, a vehicle computing system 106, and one or more vehicle controls 108. The vehicle computing system 106 can assist in controlling the autonomous vehicle 102. In particular, the vehicle computing system 106 can receive sensor data from the one or more sensors 104, attempt to comprehend the surrounding environment by performing various processing techniques on data collected by the sensors 104, and generate an appropriate motion path through such surrounding environment. The vehicle computing system 106 can control the one or more vehicle controls 108 to operate the autonomous vehicle 102 according to the motion path.

The vehicle computing system 106 can include one or more processors 130 and at least one memory 132. The one or more processors 130 can be any suitable processing device (e.g., a processor core, a microprocessor, an ASIC, a FPGA, a controller, a microcontroller, etc.) and can be one processor or a plurality of processors that are operatively connected. The memory 132 can include one or more non-transitory computer-readable storage mediums, such as RAM, ROM, EEPROM, EPROM, flash memory devices, magnetic disks, etc., and combinations thereof. The memory 132 can store data 134 and instructions 136 which are executed by the processor 130 to cause vehicle computing system 106 to perform operations.

In some implementations, vehicle computing system 106 can further be connected to, or include, a positioning system 120. Positioning system 120 can determine a current geographic location of the autonomous vehicle 102. The positioning system 120 can be any device or circuitry for analyzing the position of the autonomous vehicle 102. For example, the positioning system 120 can determine actual or relative position by using a satellite navigation positioning system (e.g. a GPS system, a Galileo positioning system, the GLObal NAvigation Satellite System (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position. The position of the autonomous vehicle 102 can be used by various systems of the vehicle computing system 106.

As illustrated in FIG. 1, in some embodiments, the vehicle computing system 106 can include a perception system 110, a prediction system 112, and a motion planning system 114 that cooperate to perceive the surrounding environment of the autonomous vehicle 102 and determine a motion plan for controlling the motion of the autonomous vehicle 102 accordingly.

In particular, in some implementations, the perception system 110 can receive sensor data from the one or more sensors 104 that are coupled to or otherwise included within the autonomous vehicle 102. As examples, the one or more sensors 104 can include a LIght Detection And Ranging (LIDAR) system 122, a RAdio Detection And Ranging (RADAR) system 124, one or more cameras 126 (e.g., visible spectrum cameras, infrared cameras, etc.), and/or other sensors 128. The sensor data can include information that describes the location of objects within the surrounding environment of the autonomous vehicle 102.

As one example, for LIDAR system 122, the sensor data can include the location (e.g., in three-dimensional space relative to the LIDAR system 122) of a number of points that correspond to objects that have reflected a ranging laser. For example, LIDAR system 122 can measure distances by measuring the Time of Flight (TOF) that it takes a short laser pulse to travel from the sensor to an object and back, calculating the distance from the known speed of light.

As another example, for RADAR system 124, the sensor data can include the location (e.g., in three-dimensional space relative to RADAR system 124) of a number of points that correspond to objects that have reflected a ranging radio wave. For example, radio waves (pulsed or continuous) transmitted by the RADAR system 124 can reflect off an object and return to a receiver of the RADAR system 124, giving information about the object's location and speed. Thus, RADAR system 124 can provide useful information about the current speed of an object.

As yet another example, for one or more cameras 126, various processing techniques (e.g., range imaging techniques such as, for example, structure from motion, structured light, stereo triangulation, and/or other techniques) can be performed to identify the location (e.g., in three-dimensional space relative to the one or more cameras 126) of a number of points that correspond to objects that are depicted in imagery captured by the one or more cameras 126. Other sensor systems 128 can identify the location of points that correspond to objects as well.

Thus, the one or more sensors 104 can be used to collect sensor data that includes information that describes the location (e.g., in three-dimensional space relative to the autonomous vehicle 102) of points that correspond to objects within the surrounding environment of the autonomous vehicle 102.

In addition to the sensor data, the perception system 110 can retrieve or otherwise obtain map data 118 that provides detailed information about the surrounding environment of the autonomous vehicle 102. The map data 118 can provide information regarding: the identity and location of different travelways (e.g., roadways), road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travelway); traffic control data (e.g., the location and instructions of signage, traffic lights, or other traffic control devices); and/or any other map data that provides information that assists the vehicle computing system 106 in comprehending and perceiving its surrounding environment and its relationship thereto.

The perception system 110 can identify one or more objects that are proximate to the autonomous vehicle 102 based on sensor data received from the one or more sensors 104 and/or the map data 118. In particular, in some implementations, the perception system 110 can determine, for each object, state data that describes a current state of such object. As examples, the state data for each object can describe an estimate of the object's: current location (also referred to as position); current speed; current heading (current speed and heading also together referred to as velocity); current acceleration; current orientation; size/footprint (e.g., as represented by a bounding shape such as a bounding polygon or polyhedron); class (e.g., vehicle versus pedestrian versus bicycle versus other); yaw rate; and/or other state information.

In some implementations, the perception system 110 can determine state data for each object over a number of iterations. In particular, the perception system 110 can update the state data for each object at each iteration. Thus, the perception system 110 can detect and track objects (e.g., vehicles, pedestrians, bicycles, and the like) that are proximate to the autonomous vehicle 102 over time.

The prediction system 112 can receive the state data from the perception system 110 and predict one or more future locations for each object based on such state data. For example, the prediction system 112 can predict where each object will be located within the next 5 seconds, 10 seconds, 20 seconds, etc. As one example, an object can be predicted to adhere to its current trajectory according to its current speed. As another example, other, more sophisticated prediction techniques or modeling can be used.

The motion planning system 114 can determine a motion plan for the autonomous vehicle 102 based at least in part on the predicted one or more future locations for the object provided by the prediction system 112 and/or the state data for the object provided by the perception system 110. Stated differently, given information about the current locations of objects and/or predicted future locations of proximate objects, the motion planning system 114 can determine a motion plan for the autonomous vehicle 102 that best navigates the autonomous vehicle 102 relative to the objects at such locations.

As one example, in some implementations, the motion planning system 114 can determine a cost function for each of one or more candidate motion plans for the autonomous vehicle 102 based at least in part on the current locations and/or predicted future locations of the objects. For example, the cost function can describe a cost (e.g., over time) of adhering to a particular candidate motion plan. For example, the cost described by a cost function can increase when the autonomous vehicle 102 approaches a possible impact with another object and/or deviates from a preferred pathway (e.g., a preapproved pathway).

Thus, given information about the current locations and/or predicted future locations of objects, the motion planning system 114 can determine a cost of adhering to a particular candidate pathway. The motion planning system 114 can select or determine a motion plan for the autonomous vehicle 102 based at least in part on the cost function(s). For example, the candidate motion plan that minimizes the cost function can be selected or otherwise determined. The motion planning system 114 can provide the selected motion plan to a vehicle controller 116 that controls one or more vehicle controls 108 (e.g., actuators or other devices that control gas flow, acceleration, steering, braking, etc.) to execute the selected motion plan.

Each of the perception system 110, the prediction system 112, the motion planning system 114, and the vehicle controller 116 can include computer logic utilized to provide desired functionality. In some implementations, each of the perception system 110, the prediction system 112, the motion planning system 114, and the vehicle controller 116 can be implemented in hardware, firmware, and/or software controlling a general purpose processor. For example, in some implementations, each of the perception system 110, the prediction system 112, the motion planning system 114, and the vehicle controller 116 includes program files stored on a storage device, loaded into a memory, and executed by one or more processors. In other implementations, each of the perception system 110, the prediction system 112, the motion planning system 114, and the vehicle controller 116 includes one or more sets of computer-executable instructions that are stored in a tangible computer-readable storage medium such as RAM hard disk or optical or magnetic media.

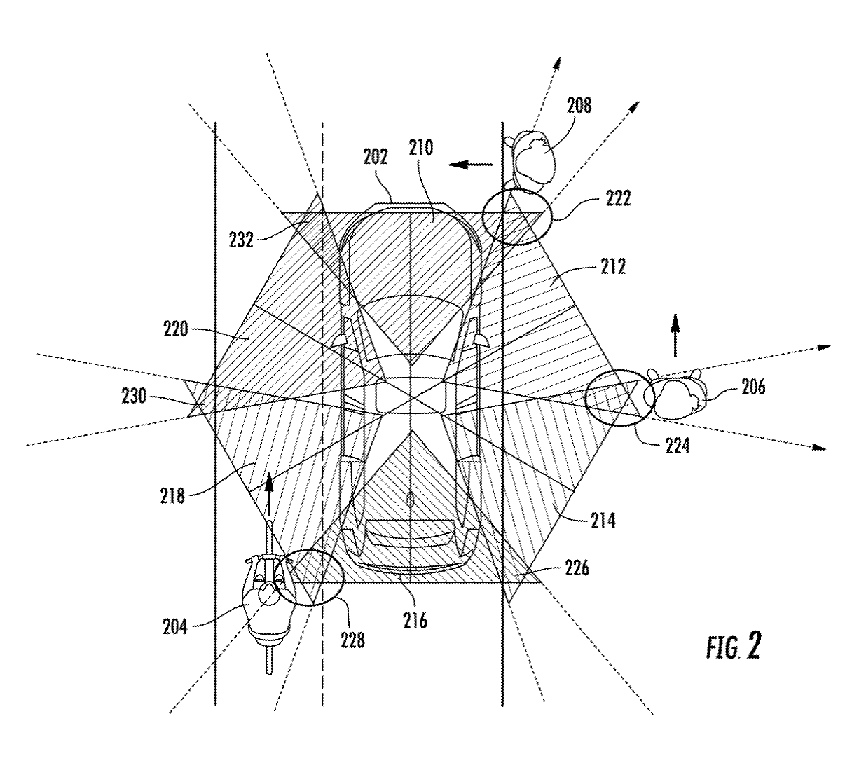

FIG. 2 illustrates fields of view for a plurality of cameras in relation to example objects of interest according to example embodiments of the present disclosure. In particular, FIG. 2 depicts an autonomous vehicle 202 having a sensor system including a plurality of cameras (not shown). The plurality of cameras, for example six cameras, are mounted and positioned, relative to the sensor system and the autonomous vehicle 202, to provide camera fields of view 210, 212, 214, 216, 218, and 220 around the periphery of the autonomous vehicle 202. While the illustrated fields of view in FIG. 2 are depicted as short triangles, camera fields of view will generally extend further than the depicted triangles in a direction away from the central vertices (e.g., the camera). In the example of FIG. 2, the plurality of cameras are positioned such that a field of view for each camera overlaps a field of view of at least one adjacent camera. More particularly, the field of view for each camera in FIG. 2 overlaps a field of view for two other cameras, including a field of view for a camera to the left and a field of view for a camera to the right of a given camera. In addition, the plurality of cameras in FIG. 2 are positioned such that a combined field of view for the plurality of cameras comprises an approximately 360-degree horizontal field of view around autonomous vehicle 202.

Further, as illustrated in FIG. 2, the cameras (not shown) are positioned to create a plurality of field of view overlaps, such as field of view overlaps 222, 224, 226, 228, 230, and 232. For example, camera field of view 210 and camera field of view 212 are configured to create field of view overlap 222. Camera field of view 212 and camera field of view 214 are configured to create field of view overlap 224. Camera field of view 214 and camera field of view 216 are configured to create field of view overlap 226. Camera field of view 216 and camera field of view 218 are configured to create field of view overlap 228. Camera field of view 218 and camera field of view 220 are configured to create field of view overlap 230. Camera field of view 220 and camera field of view 202 are configured to create field of view overlap 232. It should be noted that the camera fields of view 210-220 and the camera field of view overlaps 222-232 need not be equivalently dimensioned, but instead, the cameras may be configured to create different sized field of view overlaps dependent on a desired view in a particular direction around autonomous vehicle 202.

As illustrated in FIG. 2, the field of view overlaps are configured in such a manner as to allow an object that would be captured in a first camera's image data on a boundary of that camera's field of view, to be more fully captured in an adjacent camera's field of view (e.g., capturing at least a sufficient portion of the object of interest by the adjacent camera to allow for classification). In one example, as pedestrian 206 moves, in relation to the autonomous vehicle 202, between camera field of view 212 and camera field of view 214, when pedestrian 206 is located on the boundary of camera field of view 212 (e.g., may not be clearly identifiable in that camera's image data), pedestrian 206 may be more fully captured within camera field of view 214 due to the configuration of the field of view overlap 224. In another example, as pedestrian 208 moves, in relation to the autonomous vehicle, between camera field of view 212 and camera field of view 210, when pedestrian 208 is located on the boundary of camera field of view 212 (e.g., may not be clearly identifiable in that camera's image data), pedestrian 208 may be more fully captured within camera field of view 210 due to the configuration of the field of view overlap 222. In another example, as bicyclist 204 moves between camera field of view 216 and camera field of view 218, when bicyclist 204 is located on the boundary of camera field of view 216 (e.g., may not be clearly identifiable in that camera's image data), bicyclist 204 may be more fully captured within camera field of view 218 due to the configuration of the field of view overlap 228, and vice versa.

One or more parameters may be used in determining how a plurality of cameras should be configured to provide camera field of view overlaps, such as field of view overlaps 222, 224, 226, 228, 230, and 232 illustrated in FIG. 2. In some implementations, one or more camera field of view overlaps 222-232 can be configured such that the field of view overlap is large enough within a certain range for a largest relevant classifiable object (e.g., a pedestrian near the autonomous vehicle) to be fully captured by one camera. In some implementations, a field of view overlap 222-232 may be configured based on a minimum amount of view of an object that is needed to determine an object classification. In some embodiments, a field of view overlap 222-232 may be configured based on a minimum or average dimension of an object type that is generally difficult to classify when captured on a camera's field of view boundary.

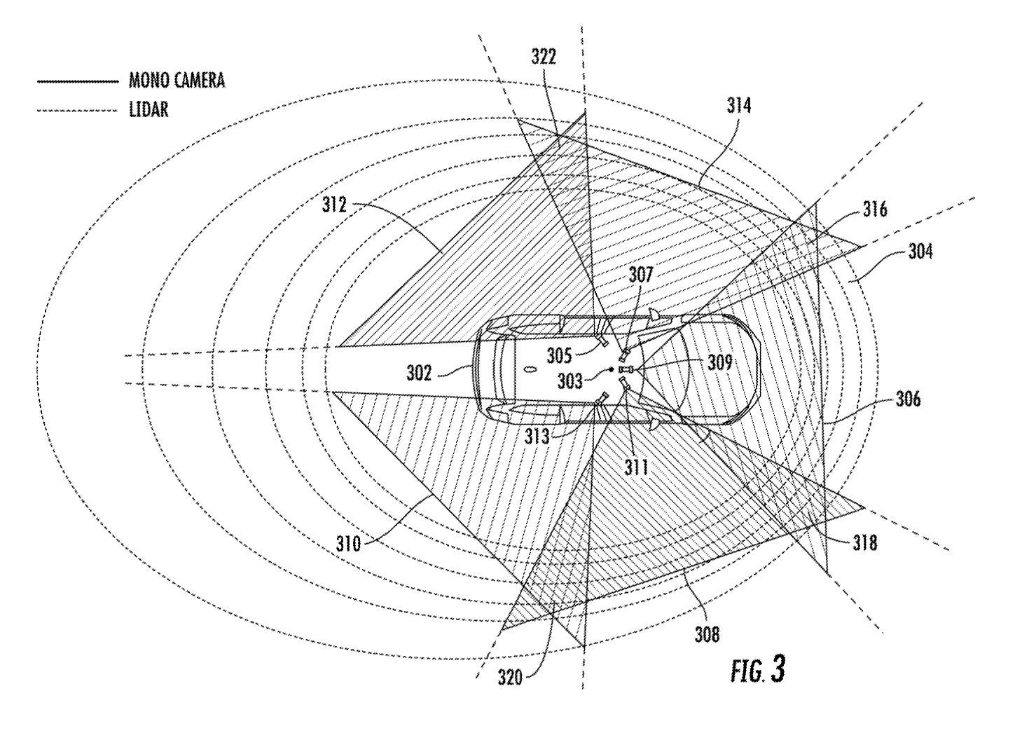

FIG. 3 depicts an example autonomous vehicle sensor system according to example embodiments of the present disclosure. In particular, FIG. 3 depicts an autonomous vehicle 302 that includes a number of sensors including a LIDAR device 303 and a plurality of cameras 305, 307, 309, 311 and 313. The plurality of cameras, for example five cameras, are mounted and positioned, relative to the LIDAR device 303 and the autonomous vehicle 302, to provide camera fields of view 306, 308, 310, 312, and 314 around the periphery of the autonomous vehicle 302. The LIDAR device 303 may also be configured to generate LIDAR sweeps 304 for use in detecting the location of objects around the autonomous vehicle 302.

As illustrated in FIG. 3, the cameras 305, 307, 309, 311 and 313 are positioned to create a plurality of field of view overlaps, such as field of view overlaps 316, 318, 320, and 322. For example, camera field of view 306 and camera field of view 308 are configured to create field of view overlap 318. Camera field of view 308 and camera field of view 310 are configured to create field of view overlap 320. Camera field of view 312 and camera field of view 314 are configured to create field of view overlap 322. Camera field of view 314 and camera field of view 306 are configured to create field of view overlap 316.

In some implementations, as illustrated in FIG. 3, one or more cameras may be configured such that no field of view overlap is created within a short distance of the autonomous vehicle 302 in a particular direction relative to the autonomous vehicle 302. In one example, two rear-facing cameras (e.g., right-side rear-facing camera 313 and left-side rear-facing camera 305) may be positioned and configured such that there is no field of view overlap between the two cameras at a short distance to the rear of the autonomous vehicle 302. Such a configuration may be based, for example, on a determination that the autonomous vehicle 302 will not reverse at a high rate of speed and/or due to other sensors that may be configured for detecting objects within a short distance of the rear of the autonomous vehicle 302 (e.g., cameras or other image sensors or proximity sensors located on a rear bumper of autonomous vehicle 302). In this example, the plurality of cameras 305, 307, 309, 311, and 313 are configured to provide some front bias in field of view overlap, for example, due to a higher likelihood of objects necessitating detection and classification approaching from the front and/or front sides of autonomous vehicle 302 while in operation.

Referring still to FIG. 3, LIDAR device 303 and some of the plurality of cameras (e.g., cameras 307, 309 and 311), may be configured in positions more forward on the roof of the autonomous vehicle 302, for example, to more closely align with a driver's head position and provide improved perception of oncoming terrain and objects. For example, forward facing camera 309 as well as forward side cameras 307 and 311, and optionally the LIDAR device 303, may all be mounted on the roof of the autonomous vehicle 302 such that they are not positioned behind a driver seat position in the autonomous vehicle 302. In some embodiments, a forward-facing camera of the sensor system (e.g., one of forward cameras 307, 309 and 311) can also be positioned and oriented to be able to see a traffic control signal while the autonomous vehicle 302 is stationary at an intersection.

The autonomous vehicle 302 may use a combination of LIDAR data generated based on the LIDAR sweeps 304 and image data generated by the cameras (within the fields of view 306-314) for the detection and classification of objects in the surrounding environment of autonomous vehicle 302, such as by a vehicle computing system 106 as discussed in regard to FIG. 1. Configuring the cameras to provide camera field of view overlaps, such as field of view overlaps 316, 318, 320, and 322, allows for improved detection and classification of objects around the autonomous vehicle by enabling an adjacent camera to capture a more complete view of an object that may not have been captured by a first camera with enough detail to allow for accurate detection and classification, as discussed above.

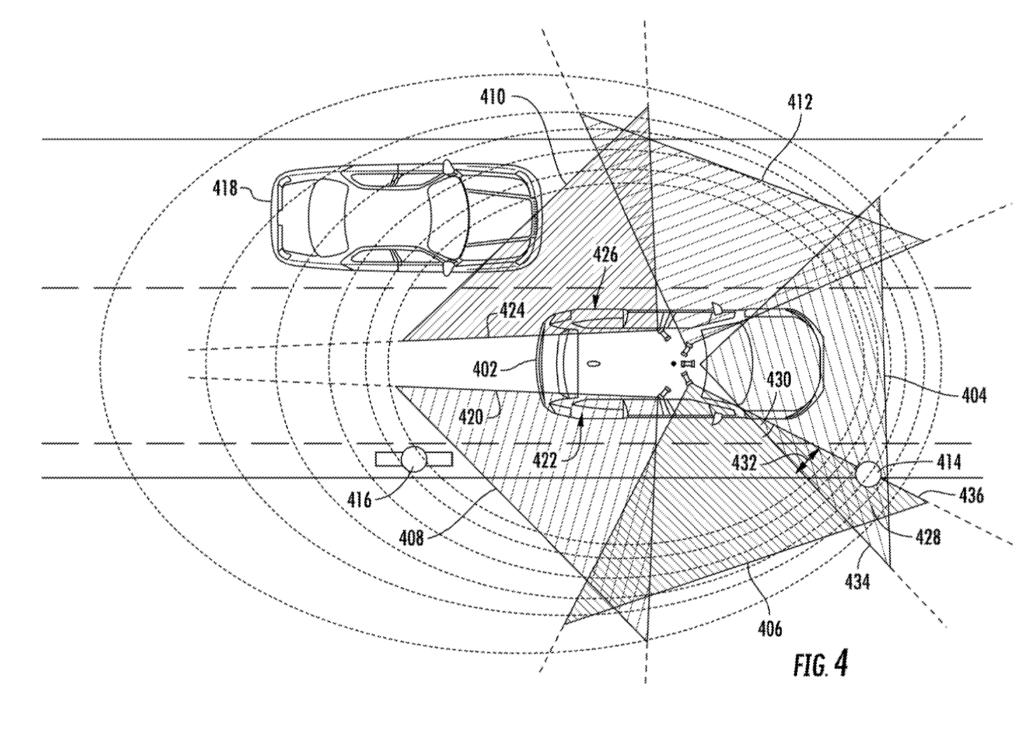

FIG. 4 depicts an example autonomous vehicle sensor system in relation to example objects of interest according to example embodiments of the present disclosure. In particular, FIG. 4 depicts an autonomous vehicle 402 that includes a number of sensors including a LIDAR device and a plurality of cameras (not shown). The plurality of cameras are mounted and positioned, relative to the LIDAR system and the autonomous vehicle 402, to provide camera fields of view 404, 406, 408, 410, and 412 around the periphery of the autonomous vehicle 402. The LIDAR device is configured to generate LIDAR sweeps for use in detecting the location of objects around the autonomous vehicle. As further illustrated in FIG. 4, the cameras are positioned to create a plurality of field of view overlaps between the camera fields of view, as discussed above.

As illustrated in FIG. 4, the field of view overlaps are configured in such a manner as to allow an object that would be captured in a first camera's image data on a boundary of that camera's field of view, to be more fully captured in an adjacent camera's field of view. In one example, as pedestrian 414 moves, in relation to the autonomous vehicle 402, pedestrian 414 may be located within camera field of view 404 and camera field of view 406. When pedestrian 414 is located on the boundary 436 of camera field of view 406 (e.g., may not be clearly identifiable in that camera's image data), pedestrian 414 may be more fully captured within camera field of view 404 due to the configuration of the field of view overlap 428 between the camera fields of view 404 and 406.

As further illustrated in FIG. 4, one or more cameras may be further configured to provide a horizontal field of view adjacent to an autonomous vehicle so that, for example, objects proximate to the vehicle in an adjacent lane, or farther back to the rear of the vehicle in an adjacent lane, can be more easily detected (e.g., for use in analyzing a lane change or merging operation of the vehicle). For example, field of view 408 has a side boundary 420 substantially aligned with a right side 422 of autonomous vehicle 402, while field of view 410 has a side boundary 424 substantially aligned with a left side 426 of autonomous vehicle. This configuration for fields of view 408 and 410 can be provided by positioning one or more rear-facing cameras (not shown) proximate to left and right roof edges of the autonomous vehicle 402. As illustrated in FIG. 4, the right-side rear-facing camera with field of view 408 can be configured to provide a horizontal field of view 408 adjacent to the right side 422 of autonomous vehicle 402 such that bicycle 416 may be more easily detected and classified as the bicycle moves adjacent to the autonomous vehicle 402. Also as illustrated in FIG. 4, the left-side rear-facing camera with field of view 410 can be configured to provide a horizontal field of view adjacent to the left side 426 of autonomous vehicle 402 such that vehicle 418 may be more easily detected and classified as vehicle 418 approaches autonomous vehicle 402 from the rear in the adjacent lane.

Specific parameters characterizing a field of view overlap, for example field of view overlap 428 between the camera fields of view 404 and 406 or any other field of view overlaps illustrated or described herein, can be defined in one or more manners. For example, field of view overlap 428 can be characterized by an angle 430 of the field of view overlap 428 formed between adjacent fields of view 404 and 406. In another example, field of view overlap can be characterized as a width dimension 432 measured between adjacent field of view boundaries (e.g., boundary 434 of field of view 404 and boundary 436 of field of view 406) at a predetermined distance from autonomous vehicle 402 or from one or more components of the sensor system mounted on autonomous vehicle 402. Other parameters characterizing a field of view overlap between adjacent cameras can be based on a distance and/or angular orientation between adjacent cameras as they are mounted within a sensor system relative to autonomous vehicle 402.

In some embodiments, one or more camera field of view overlaps (e.g., field of view overlap 428) can be configured such that the field of view overlap 428 is large enough in certain locations for a largest relevant classifiable object to be fully captured by one camera (e.g., camera 404 or 406). For example, having a pedestrian category for object classification field of view overlap 428 can be configured to be large enough within a certain range of the autonomous vehicle so that a larger pedestrian (e.g., male pedestrian 414, with an average male pedestrian generally being larger than average female or child pedestrians) near the autonomous vehicle may be fully viewed in at least one camera's field of view 404, 406, 408, 410, 412 when pedestrian 414 is proximate to autonomous vehicle 402. As such, when pedestrian 414 is located on a boundary 434 of camera field of view 406, pedestrian 414 can be fully captured in the adjacent camera field of view 404 due to field of view overlap 428. As such, it may be desirable that field of view overlap 428 is characterized by a minimum or average dimension of an object class, such as pedestrian 414. For example field of view overlap 428 may be characterized by a width dimension 432 measured relatively close to autonomous vehicle 402 of between about 20-24 inches (e.g., based on a reference dimension of 20 inches for the width of a male pedestrian). When width dimension 432 is measured farther from autonomous vehicle 402 between adjacent field of view boundaries (e.g., boundary 434 of field of view 404 and boundary 436 of field of view 406), the field of view overlap 428 is wider and more likely to fully encompass an object such as pedestrian 414.

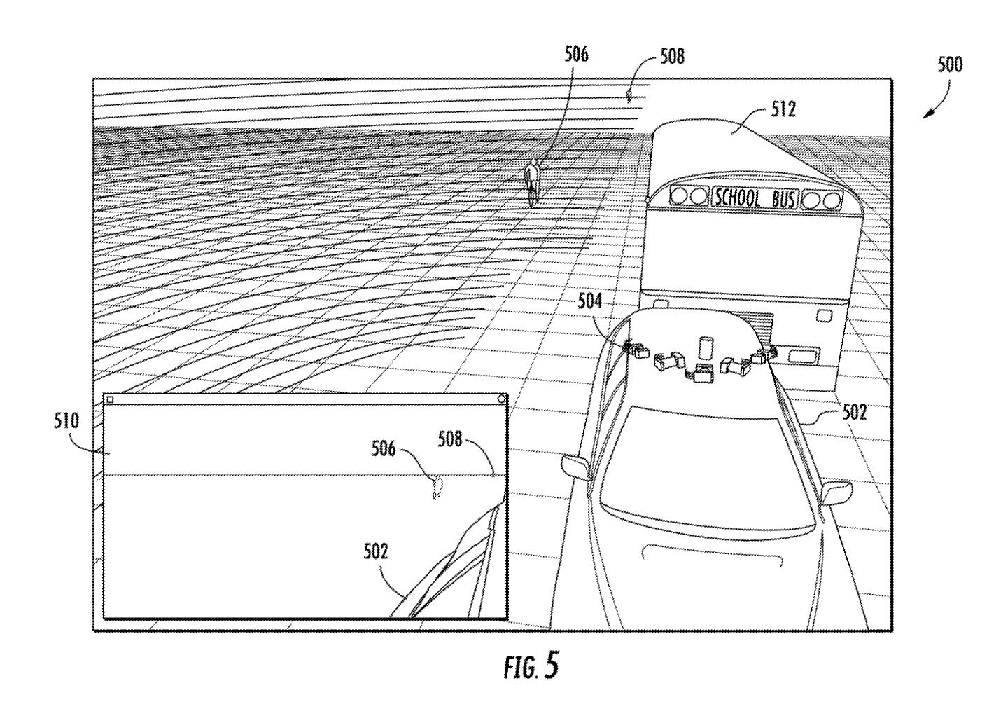

FIG. 5 depicts a graphical illustration of adjacent rear view detection according to example embodiments of the present disclosure. As illustrated in FIG. 5, autonomous vehicle 502 includes a number of sensors, including a rear-facing right side camera 504. The rear facing camera right side 504 is configured such that it provides a horizontal field of view adjacent and to the rear of the right side of autonomous vehicle 502. In some embodiments, one or more rear facing cameras may be positioned near the roof edge of the autonomous vehicle so that the rear facing camera can provide an improved view as compared to a rear camera placed on the centerline of an autonomous vehicle. For example, having a rear facing camera positioned near a roof edge of the autonomous vehicle can provide an improved rear facing view of the adjacent lane when a large vehicle (e.g., bus, truck, etc.) is positioned immediately behind the autonomous vehicle (as depicted in FIG. 5), whereas a rear camera positioned near the vehicle centerline could have its field of view largely obscured by the large vehicle.

Inset window 510 illustrates an example horizontal adjacent view captured by rear facing camera 504, including objects such as bicycle 506 and motorcycle 508 which are positioned behind and to the right of autonomous vehicle 502. As illustrated in FIG. 5, the placement of rear-facing right side camera 504 can provide a rear view of more distant objects (e.g., motorcycle 508) in the right adjacent lane when a large vehicle, such as bus 512, is located immediately behind the autonomous vehicle 502. By configuring the rear facing camera 504 to provide the horizontal field of view adjacent and to the rear of autonomous vehicle 502, autonomous vehicle 502 may more easily detect and classify bicycle 506 and motorcycle 508 as objects of interest that should be considered when determining candidate motion plans, such as by a vehicle computing system, as previously discussed.

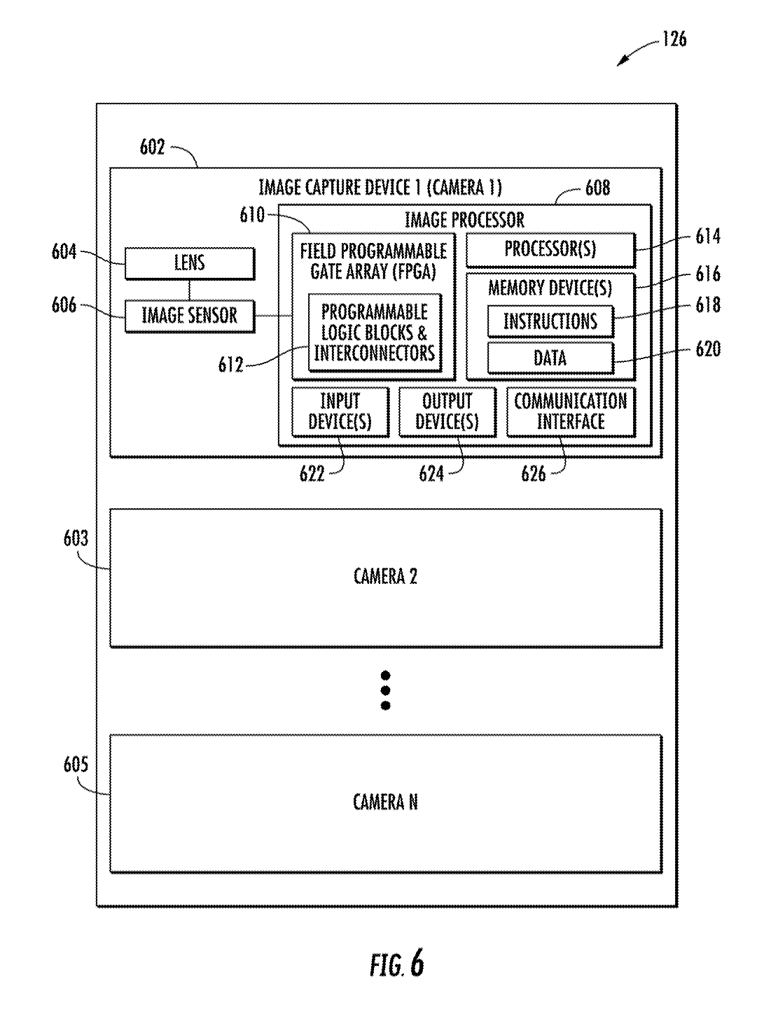

FIG. 6 depicts a block diagram of a camera system according to example embodiments of the present disclosure. In particular, FIG. 6 depicts an example embodiment of camera(s) 126 of a sensor system, such as sensor system including sensors 104 of FIG. 1, whereby camera(s) 126 can generate image data for use by a vehicle computing system in an autonomous vehicle, such as vehicle computing system 106 of FIG. 1, as discussed above. In some implementations, camera(s) 126 include a plurality of camera devices (e.g., image capture devices), such as camera 602, camera 603, and camera 605. Although only the components of camera 602 are discussed herein in further detail, it should be appreciated that cameras 2, . . . , N (e.g., camera 603 and camera 605) can include similar components as camera 602. In some implementations, the autonomous vehicle sensor system, such as sensors 104 of FIG. 1, may include at least five cameras, at least six cameras, or more or less cameras depending on the desired fields of view.

Camera 602 can include one or more lenses 604, an image sensor 606, and one or more image processors 608. Camera 602 can also have additional conventional camera components not illustrated in FIG. 6 as would be understood by one of ordinary skill in the art. When a shutter of camera 602 is controlled to an open position, incoming light passes through lens 604 before reaching image sensor 606. Lens 604 can be positioned before, between and/or after a shutter of camera 602 to focus images captured by camera 602. Image sensor 606 can obtain raw image capture data in accordance with a variety of shutter exposure protocols by which a shutter is controlled to expose image sensor 606 to incoming light.

In some examples, the image sensor 606 can be a charge-coupled device (CCD) sensor or a complementary metal-oxide-semiconductor (CMOS) sensor, although other image sensors can also be employed. Image sensor 606 can include an array of image sensor elements corresponding to unique image pixels that are configured to detect incoming light provided incident to a surface of image sensor 606. Each image sensor element within image sensor 606 can detect incoming light by detecting the amount of light that falls thereon and converting the received amount of light into a corresponding electric signal. The more light detected at each pixel, the stronger the electric signal generated by the sensor element corresponding to that pixel. In some examples, each image sensor element within image sensor 606 can include a photodiode and an amplifier along with additional integrated circuit components configured to generate the electric signal representative of an amount of captured light at each image sensor element. The electric signals detected at image sensor 606 provide raw image capture data at a plurality of pixels, each pixel corresponding to a corresponding image sensor element within image sensor 606. Image sensor 606 can be configured to capture successive full image frames of raw image capture data in successive increments of time.

As illustrated in FIG. 6, camera 602 also can include one or more image processing devices (e.g., image processors) 608 coupled to image sensor 606. In some examples, the one or more image processors 608 can include a field-programmable gate array (FPGA) 610 provided within the camera 602. FPGA 610 can include a plurality of programmable logic blocks and interconnectors 612. Specific configurations of the plurality of programmable logic blocks and interconnectors 612 can be selectively controlled to process raw image capture data received from image sensor 606. One or more image data links can be provided to couple the one or more image processors 608 to image sensor 606. In some examples, each image data link can be a high speed data link that can relay relatively large amounts of image data while consuming a relatively low amount of power. In some examples, image data link(s) can operate using different signaling protocols, including but not limited to a Low-Voltage Differential Signaling (LVDS) protocol, a lower voltage sub-LVDS protocol, a Camera Serial Interface (CSI) protocol using D-PHY and/or M-PHY physical layers, or other suitable protocols and interface layers.

The one or more image processors 608 can include one or more processor(s) 614 along with one or more memory device(s) 616 that can collectively function as respective computing devices. The one or more processor(s) 614 can be any suitable processing device such as a microprocessor, microcontroller, integrated circuit, an application specific integrated circuit (ASIC), a digital signal processor (DSP), a field-programmable gate array (FPGA), logic device, one or more central processing units (CPUs), processing units performing other specialized calculations, etc. The one or more processor(s) 614 can be a single processor or a plurality of processors that are operatively and/or selectively connected.

The one or more memory device(s) 616 can include one or more non-transitory computer-readable storage media, such as RAM, ROM, EEPROM, EPROM, flash memory devices, magnetic disks, etc., and/or combinations thereof. The one or more memory device(s) 616 can store information that can be accessed by the one or more processor(s) 614. For instance, the one or more memory device(s) 616 can include computer-readable instructions 618 that can be executed by the one or more processor(s) 614. The instructions 618 can be software written in any suitable programming language, firmware implemented with various controllable logic devices, and/or can be implemented in hardware. Additionally, and/or alternatively, the instructions 620 can be executed in logically and/or virtually separate threads on processor(s) 614. The instructions 618 can be any set of instructions that when executed by the one or more processor(s) 614 cause the one or more processor(s) 614 to perform operations.

The one or more memory device(s) 616 can store data 620 that can be retrieved, manipulated, created, and/or stored by the one or more processor(s) 614. The data 620 can include, for instance, raw image capture data, digital image outputs, or other image-related data or parameters. The data 620 can be stored in one or more database(s). The one or more database(s) can be split up so that they can be provided in multiple locations.

Camera 602 can include a communication interface 624 used to communicate with one or more other component(s) of a sensor system or other systems of an autonomous vehicle, for example, a vehicle computing system such as vehicle computing system 106 of FIG. 1. The communication interface 624 can include any suitable components for interfacing with one or more communication channels, including for example, transmitters, receivers, ports, controllers, antennas, or other suitable hardware and/or software. A communication channel can be any type of communication channel, such one or more data bus(es) (e.g., controller area network (CAN)), an on-board diagnostics connector (e.g., OBD-II) and/or a combination of wired and/or wireless communication links for sending and/or receiving data, messages, signals, etc. among devices/systems. A communication channel can additionally or alternatively include one or more networks, such as a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the camera 602 and/or other local autonomous vehicle systems or associated server-based processing or control systems located remotely from an autonomous vehicle. The communication channel can include a direct connection between one or more components. In general, communication using communication channels and/or among one or more component(s) can be carried via communication interface 624 using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

Camera 602 also can include one or more input devices 620 and/or one or more output devices 622. An input device 620 can include, for example, devices for receiving information from a user, such as a touch screen, touch pad, mouse, data entry keys, speakers, a microphone suitable for voice recognition, etc. An input device 620 can be used, for example, by a user to select controllable inputs for operation of the camera 602 (e.g., shutter, ISO, white balance, focus, exposure, etc.) and or control of one or more parameters. An output device 622 can be used, for example, to provide digital image outputs to a vehicle operator. For example, an output device 622 can include a display device (e.g., display screen, CRT, LCD), which can include hardware for displaying an image or other communication to a user. Additionally, and/or alternatively, output device(s) can include an audio output device (e.g., speaker) and/or device for providing haptic feedback (e.g., vibration).

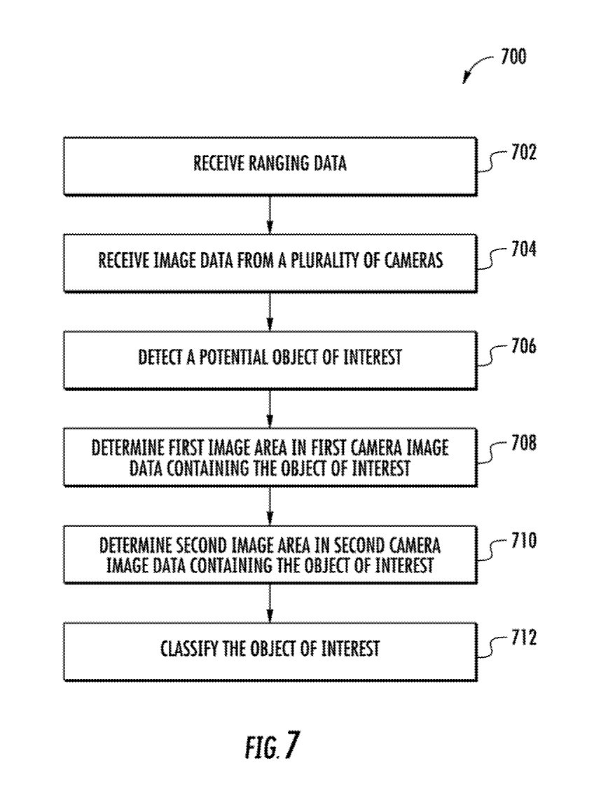

FIG. 7 depicts a flow chart diagram of an example method 700 of providing sensor data for use in object detection according to example embodiments of the present disclosure. Ranging data (e.g., LIDAR data) can be received by one or more computing devices in a computing system at 702, for example, from one or more ranging devices included in a sensor system, such as sensor system including sensors 104 of FIG. 1. Such ranging data can include data regarding locations of objects within a surrounding environment of an autonomous vehicle (e.g., data indicating the locations (relative to the LIDAR device) of a number of points that correspond to objects that have reflected a ranging laser).

At 704, one or more computing devices in a computing system, such as vehicle computing system 106 of FIG. 1, can receive image data from a plurality of cameras associated with or coupled to the sensor system, for example, camera(s) 126 of FIG. 1. The image data can include image data associated with one or more objects in the surrounding environment of the autonomous vehicle captured by each camera's field of view. The image data can include, for each camera, views of objects located within the camera's field of view or partial views of objects located on an edge or boundary of the camera's field of view. In some examples, image data obtained at 704 can be synchronized with ranging data received at 702 such that objects detected within the image data received at 704 can be localized. For example, an estimated location within three-dimensional space around a vehicle for an object detected within the image data obtained at 704 can be determined at least in part from ranging data received at 702 that is synchronized with image data received at 704.

At 706, the one or more computing devices within a computing system can detect a potential object of interest within the received image data from the plurality of cameras. At 708, the computing system can determine a first image area in a first camera's image data that contains, at least partially, the potential object of interest. At 710, the computing system can determine a second image area in a second camera's image data that contains, at least partially, the potential object of interest. In some examples, the second image area in the second camera image data may overlap the first image area in the first camera image data by a defined amount (e.g., based on the configuration of the plurality of cameras). The first image area in the first camera image data may contain only a partial view of the object of interest because, for example, the potential object of interest may fall at or near a boundary edge of the first camera's field of view. The second image area in the second camera image data may contain a more complete view of the object of interest due to the overlap with the first image area in the first camera image data.

At 712, the one or more computing devices in a computing system may classify the object of interest based in part on the second camera image data and provide the object classification for use in further operations, such as tracking and prediction. For example, the partial view of the object of interest contained in the first image area in the first camera image data determined at 708 may not provide enough data for accurate localization and classification of the object of interest. However, the more full view of the object of interest in the second image area in the second camera image data determined at 708 due to the view overlap may provide sufficient data for accurate localization and classification of the object of interest.

Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

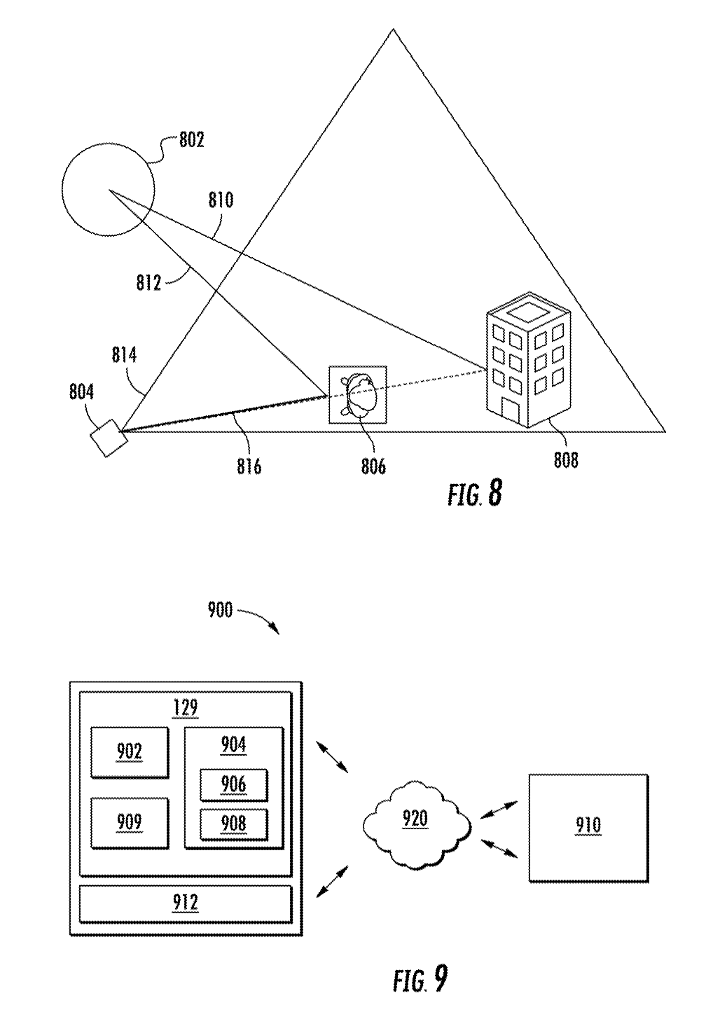

FIG. 8 illustrates an example of camera-LIDAR parallax. Parallax is a difference in an apparent position of an object viewed along two different lines of sight, such as objects “viewed” relative to the position of a LIDAR device and also “viewed” relative to the placement of one or more cameras. For example, as illustrated in FIG. 8, two objects, a person 806 and a building 808, may be viewed by a first sensor 802, for example a ranging device such as a LIDAR device, as having apparent positions next to each other based on ranging signal returns, such as ranging signal 810 and ranging signal 812. Data from the first sensor 802 may indicate from the perspective of the first sensor 802 that the person 806 is positioned to the right of the building 808. However, due to the difference in placement, a second sensor 804, for example a camera, may view the two objects (e.g., person 806 and building 808) in its field of view 814 as being approximately in line with each other along a sight line, such as sight line 816. For example, the data from second sensor 804 may indicate that the person 806 is positioned in front of the building 808 along sight line 816. Additionally, parallax could introduce some range ambiguity in object detection due to the issue that LIDAR ranges could be ambiguous. For example, the person 806 may be detected in a certain direction based on a camera image, but it may be uncertain for object detection whether it is located at the distance of the person or the distance of the building behind it based on the LIDAR data since the LIDAR ranges could be ambiguous. However, by configuring the placement and orientation of one or more cameras relative to a LIDAR system in accordance with embodiments of the present disclosure, errors in the localization of objects caused by such parallax effects may be reduced. For instance, the LIDAR system can be centrally mounted with the plurality of cameras. Although the cameras can be placed in different locations to increase field of view overlap and provide specific field of view locations relative to a vehicle, the camera placement and orientation can also be designed to reduce parallax by enhancing the overlap across potential sight line locations between the LIDAR system and the cameras.

FIG. 9 depicts an example computing system 900 according to example embodiments of the present disclosure. The example system 900 illustrated in FIG. 9 is provided as an example only. The components, systems, connections, and/or other aspects illustrated in FIG. 9 are optional and are provided as examples of what is possible, but not required, to implement the present disclosure. The example system 900 can include the vehicle computing system 106 of the vehicle 102 and, in some implementations, a remote computing system 910 including remote computing device(s) that is remote from the vehicle 102 and that can be communicatively coupled to one another over one or more networks 920. The remote computing system 910 can be associated with a central operations system and/or an entity associated with the vehicle 102 such as, for example, a vehicle owner, vehicle manager, fleet operator, service provider, etc.

The computing device(s) 129 of the vehicle computing system 106 can include processor(s) 902 and a memory 904. The one or more processors 902 can be any suitable processing device (e.g., a processor core, a microprocessor, an ASIC, a FPGA, a controller, a microcontroller, etc.) and can be one processor or a plurality of processors that are operatively connected. The memory 904 can include one or more non-transitory computer-readable storage media, such as RAM, ROM, EEPROM, EPROM, one or more memory devices, flash memory devices, etc., and combinations thereof.

The memory 904 can store information that can be accessed by the one or more processors 902. For instance, the memory 904 (e.g., one or more non-transitory computer-readable storage mediums, memory devices) on-board the vehicle 102 can include computer-readable instructions 906 that can be executed by the one or more processors 902. The instructions 906 can be software written in any suitable programming language or can be implemented in hardware. Additionally, or alternatively, the instructions 906 can be executed in logically and/or virtually separate threads on processor(s) 902.

For example, the memory 904 on-board the vehicle 102 can store instructions 906 that when executed by the one or more processors 902 on-board the vehicle 102 cause the one or more processors 902 (the computing system 106) to perform operations such as any of the operations and functions of the computing device(s) 129 or for which the computing device(s) 129 are configured, as described herein and including, for example, steps 702-712 of method 700 in FIG. 7.

The memory 904 can store data 908 that can be obtained, received, accessed, written, manipulated, created, and/or stored. The data 908 can include, for instance, ranging data obtained by LIDAR system 122 and/or RADAR system 124, image data obtained by camera(s) 126, data identifying detected and/or classified objects including current object states and predicted object locations and/or trajectories, motion plans, etc. as described herein. In some implementations, the computing device(s) 129 can obtain data from one or more memory device(s) that are remote from the vehicle 102.

The computing device(s) 129 can also include a communication interface 909 used to communicate with one or more other system(s) on-board the vehicle 102 and/or a remote computing device that is remote from the vehicle 102 (e.g., of remote computing system 910). The communication interface 909 can include any circuits, components, software, etc. for communicating with one or more networks (e.g., 920). In some implementations, the communication interface 909 can include for example, one or more of a communications controller, receiver, transceiver, transmitter, port, conductors, software and/or hardware for communicating data.

In some implementations, the vehicle computing system 106 can further include a positioning system 912. The positioning system 912 can determine a current position of the vehicle 102. The positioning system 912 can be any device or circuitry for analyzing the position of the vehicle 902. For example, the positioning system 912 can determine position by using one or more of inertial sensors, a satellite positioning system, based on IP address, by using triangulation and/or proximity to network access points or other network components (e.g., cellular towers, WiFi access points, etc.) and/or other suitable techniques. The position of the vehicle 102 can be used by various systems of the vehicle computing system 106.

The network(s) 920 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) 920 can be accomplished, for instance, via a communication interface using any type of protocol, protection scheme, encoding, format, packaging, etc.

The remote computing system 910 can include one or more remote computing devices that are remote from the vehicle computing system 106. The remote computing devices can include components (e.g., processor(s), memory, instructions, data) similar to that described herein for the computing device(s) 129.

Computing tasks discussed herein as being performed at computing device(s) remote from the vehicle can instead be performed at the vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A sensor system comprising:
one or more ranging systems; and
a plurality of cameras,
the plurality of cameras positioned such that a field of view for each camera of the plurality of cameras overlaps a field of view of at least one adjacent camera,
the plurality of cameras further positioned about at least one of the one or more ranging systems such that a combined field of view of the plurality of cameras comprises an approximately 360-degree field of view;
wherein the one or more ranging systems are configured to transmit ranging data to a perception system for detecting objects of interest; and
wherein the plurality of cameras are configured to transmit image data to the perception system for classifying the objects of interest.

2. The sensor system of claim 1, wherein the plurality of cameras are positioned such that an object partially viewed by a first camera on a boundary of a first camera field of view will be fully viewed by a second camera adjacent to the first camera within a second adjacent camera field of view, thereby providing a full view of the object to replace any split view of the object captured by the first camera.

3. The sensor system of claim 1, wherein the plurality of cameras are positioned such that an object at least partially viewed within a first image area on a boundary of a first camera field of view will also be viewed within a second image area in an adjacent camera field of view, the second image area overlapping the first image area and providing a greater view of the object than provided in the first image area.

4. The sensor system of claim 1, wherein each camera field of view comprises a horizontal field of view of about 90 degrees.

5. The sensor system of claim 1, wherein the one of the one or more ranging systems comprises a light detection and ranging (LIDAR) device.

6. The sensor system of claim 5, wherein the LIDAR device is centrally mounted relative to the plurality of cameras.

7. The sensor system of claim 5, wherein one or more of the plurality of cameras are positioned and oriented relative to the LIDAR device to reduce parallax effects relative to objects detected within the ranging data from the LIDAR device and within the image data from the plurality of cameras.

8. The sensor system of claim 1, wherein a field of view overlap among a first set of the plurality of cameras is greater than a field of view overlap among a second set of the plurality of cameras.

9. The sensor system of claim 1, wherein the plurality of cameras comprise:
a forward-facing camera;
two forward side cameras; and
two rear side cameras.

10. The sensor system of claim 9, wherein the plurality of cameras further comprise a rear-facing camera.

11. An autonomous vehicle comprising:
a vehicle computing system comprising:
one or more processors; and
one or more memories including instructions that, when executed by the one or more processors, cause the one or more processors to perform operations, the operations comprising:
detecting objects of interest; and
classifying the detected objects of interest;
a sensor system comprising:
a plurality of cameras, the plurality of cameras positioned such that a field of view for each camera of the plurality of cameras overlaps a field of view of at least one adjacent camera; and
wherein the plurality of cameras are configured to transmit image data to the vehicle computing system for classifying objects of interest.

12. The autonomous vehicle of claim 11, further comprising:
one or more ranging systems;
wherein the one or more ranging systems are configured to transmit ranging data to the vehicle computing system for detecting where the objects of interest are located proximate to the autonomous vehicle.

13. The autonomous vehicle of claim 11, wherein the vehicle computing system classifies the objects of interest within image data from the plurality of cameras as one or more of a vehicle, a bicycle, or a pedestrian.

14. The autonomous vehicle of claim 11, wherein one or more of the plurality of cameras are configured to provide a front bias in a field of view overlap.

15. The autonomous vehicle of claim 11, wherein a field of view overlap among two or more forward facing cameras is greater than a field of view overlap of two or more rearward facing cameras.

16. The autonomous vehicle of claim 11, wherein the sensor system is mounted on a roof of the autonomous vehicle.

17. The autonomous vehicle of claim 16, wherein the plurality of cameras includes one or more forward facing cameras mounted on the roof of the autonomous vehicle in a position closer to a front of the autonomous vehicle than a position of a driver seat within the autonomous vehicle.

18. The autonomous vehicle of claim 16, wherein the plurality of cameras comprises:
at least one left rear side camera mounted on a left side of the roof of the autonomous vehicle to provide a view of a left lane adjacent to the autonomous vehicle; and
at least one right rear side camera mounted on a right side of the roof of the autonomous vehicle to provide a view of a right lane adjacent to the autonomous vehicle.

19. The autonomous vehicle of claim 18, wherein the left rear side camera is mounted near the left edge of the roof of the autonomous vehicle and wherein the right rear side camera is mounted near the right edge of the roof of the autonomous vehicle.

20. A computer-implemented method of detecting objects of interest comprising:
receiving, by one or more computing devices, ranging data from one or more ranging systems configured to transmit ranging signals relative to an autonomous vehicle;
receiving, by the one or more computing devices, image data from a plurality of cameras configured to capture images relative to the autonomous vehicle, the plurality of cameras positioned such that a field of view for each camera of the plurality of cameras overlaps a field of view of at least one adjacent camera;
detecting, by the one or more computing devices, an object of interest proximate to the autonomous vehicle within the ranging data;
determining, by the one or more computing devices, a first image area within image data captured by a first camera within the plurality of cameras containing the object of interest;
determining, by the one or more computing devices, a second image area within image data captured by a second camera within the plurality of cameras containing the object of interest, the second image area overlapping the first image area and providing a greater view of the object than provided in the first image area; and
classifying, by the one or more computing devices, the object of interest based at least in part on the second image area.
